(19) United States
(12) Patent Application Publication
(10) Pub. No.: US 2002/0069504 A1
(43) Pub. Date: Jun. 13, 2002

(54) Faller bars

(76) Inventor: Brian Arthur Shaw, West Yorkshire (GB)

Correspondence Address: Kohn & Associates, Suite 410, 30500 Northwestern Hwy, Farmington Hills, MI, 48334, US

(21) Appl. No.: 09/977,744

(22) Filed: Oct. 15, 2001

(30) Foreign Application Priority Data
Oct. 20, 2000 (GB) UK 00 25748.5

(51) Int. Cl. B29C 65/00

(52) U.S. Cl. 29/460; 264/241

(57) ABSTRACT

A steel bar 12 is located in a mold. A plug 22 is inserted through the end of the mold to contact a recess in the end of the portion 14 of the bar and plugs 24 are inserted through the sides of the mold into grooves 20. The plugs hold the bar in position whilst carbon fiber is injected around the bar and around portions of pins 26 to fix the pins 26 in relation to the bar.

### CROSS REFERENCE TO RELATED APPLICATIONS

This applications claims priority to United Kingdom Application No. UK 00 25748.5, filed Oct. 20, 2000, which is incorporated herein by reference.

### TECHNICAL FIELD

The present invention relates to faller bars and methods of making faller bars.

### BACKGROUND OF THE INVENTION

In a prior method of making faller bars, a metal bar is generally rectangular in cross section. A series of pins are held above the bar in close proximity to, or touching the bar. The bar is held in place by two pairs of spaced opposing pegs that come in from each side to bear against the walls of the bar. The bar is located in a mold and plastic is then injection molded around the bar and around part of the pins in order to firmly attach the pins to the bar.

The pegs have to exert a very significant force onto the bar in order to hold the bar still as the bar tends to slide relative to the pegs, particularly under the force of injection molding. Consequently a powerful mechanism is required to push the pegs in to hold the bar in place.

Furthermore, the bars are formed without an end for driving the bars. Accordingly, a cranked driving end has to be welded on.

With these prior art faller bars, the moment of inertia about the longitudinal axis is such that, during molding or in use, they can flex to alter the line of the pins along their length relative to the surface being combed.

It is an object of the present invention to attempt to overcome at least one of the above or other disadvantages.

### SUMMARY OF THE INVENTION

According to one aspect of the present invention a faller bar includes an elongate bar and a molded pin support, the bar including recesses on opposite sides.

At least one, and preferably both recesses may be located at or towards at least one and region of the molded pin support.

At least one of the recesses, and preferably both the recesses may extend along the sides of the bar. At least one, and preferably both of the recesses may extend along substantially the complete co-extent of the bar with the molded pin support.

At least one of the recesses, and preferably both of the recesses may comprise, in cross-section, a generally “U” shaped recess.

The recesses may form a bar, in cross-section, of a generally I-shape.

The bar may be generally circular in cross-section prior to the recesses being formed.

The bar may be machining metal.

The bar may include a drive portion at one end and the drive portion may be integral with the bar. The drive portion and the bar may be machined from a common piece of metal bar.

The bar may include an axially facing recess at least one end.

According to a further aspect of the present invention a method of making a faller bar comprises placing a bar in a mold and at least partially locating the bar in the mold by inserting holders from opposed sides into recess on opposite sides of the bar and subsequently molding pin support material at least partially around the bar and around part of a series of pins.

The method may comprise inserting the holders into the recesses with the holders being generally aligned with each other.

The method may comprise inserting holders into at least two spaced recessed parts of the bar from at least one side.

The method may comprise inserting holders into two recessed portions of the bar from both sides of the bar. The method may comprise inserting at least two spaced holders from one side of the bar and inserting at least two spaced holders from the other side of the bar with each of the holders from one side being aligned with a holder from the other side.

At least one holder may be located towards an end region of the pin support material.

The method may comprise inserting a holder with a recess such that the holder is able to engage with the bar to restrict relative longitudinal movement of the bar and holder.

The method may comprise inserting a holder into a recess that extends along the bar, for instance into a recess that extends along substantially the complete co-extent of the pin support material.

The holders may be arranged to at least partially support the bar in the mold to resist movement in an upwards direction, a downwards direction or at least one direction extending in the direction of elongate extent of the bar including any one of those directions or any combination thereof including all of those relative directions.

The method may comprise inserting holders that do not contact the innermost part of the recess. The method may comprise inserting holders from opposed sides that permit an extremely small amount of movement of the bar form side-to-side at the location of the holders.

The method may comprise inserting a holder into an end portion of the bar to resist movement in at least one direction extending in the axial extent of the bar.

The method may comprise bending an end portion of the bar to form a driving portion. The method may comprise bending the end portion before or after molding the pin support material. The method may comprise bending an end portion of the bar that is integral with the bar. The method may comprise rotationally holding the bar during molding by restricting movement of the bent end portion about the elongate axis of the bar.

According to a further aspect of the present invention a faller bar includes an elongate bar arranged, in use, to be substantially co-extensive with a row of pins and a drive portion arranged, in use, to be powered to control the movement of the faller bar characterized in that the elongate bar and the drive portion are integral.

The drive portion may extend at an angle to the elongate extent of the elongate bar along at least part of its extent. The drive portion may include an end portion whose elongate extent is offset from the elongate extent of the elongate bar and may be offset to be parallel thereto.

The elongate bar and the drive portion may have been machined out of a common piece of metal such as a metal bar which may have been a metal bar of round cross-section. The general diameter of the elongate bar may be less than the general diameter of the drive portion.

According to another aspect of the present invention a method of making a faller bar comprises making an elongate bar integral with a drive portion with a row of pins being secured to the elongate bar.

The method may comprise bending the bar in order that at least part of the drive portion can extend at an angle to the elongate extent of the elongate bar. The method may comprise bending the drive portion after the row of pins have been attached thereto.

The present invention includes any combination of the herein referred to features or limitations.

### BRIEF DESCRIPTION OF THE DRAWINGS

The present invention can be carried into practice in various ways, but one embodiment will now be described, by way of example, and with reference to the accompanying drawings, in which:

FIG. 1 is a side view of a faller bar 10;

FIG. 2 is a plan view of FIG. 1;

FIG. 3 is a cross sectional view through FIG. III-III of FIG. 1;

FIG. 4 is a side view of the bar 12 included in FIG. 1; and

FIG. 5 is a plan view of FIG. 4.

### DETAILED DESCRIPTION

The bar 12 shown in the figures is machined from a single piece of steel which is circular is cross section along the majority of its extent. The bar 12 includes a portion 14 that is arranged to be encased in carbon fiber 16. The portion 14 is of slightly less diameter than the exposed portion comprising the driving end 18 of the bar.

The portion 14 includes grooves 20 each extending on opposed sides of the portion 14 towards the end of the portion 14 but not quite reaching that end.

In use, the bar is placed in a mold having the shape of the carbon fiber. A plug 22 is inserted through the end of the mold to contact a recess in the end of the portion 14. Plugs 24 are inserted through the sides of the mold into the groove 20. Plugs are inserted from each side of the mold in line with each other to firmly hold the bar in position in the mold. The plugs 24 can be located towards the end of the grooves 20 in order to prevent movement of the bar in its longitudinal direction as well as to support the bar in the mold. Alternatively, the plugs 24 can be spaced inwardly from the ends of the grooves. As the plugs 22 can cooperate with the top and bottom surfaces of the groove and indeed are arranged to be a snug fit in those grooves and may be loosely located in the grooves.

The carbon fiber is injected from beneath or from one or both ends or any combination thereof into the mold under considerable pressure to flow around the bar and around pins 26 that extend down into the mold and that contact the top of the portion 14 or are adjacent to that portion 14. The carbon fiber is caused to take up the shape shown. The portion 18 of the bar, which is of a slightly larger diameter than the portion 14 abuts the end of the mold to restrict movement of the bar in a longitudinal direction that may tend to take the portion 18 into the mold. The portion 14 is approximately the same diameter as the end part 26 of the carbon fiber or slightly larger.

The carbon fiber comprises a mixture of nylon resin including approximately 40% by volume of carbon fibers.

After molding the carbon fiber around the pins and the portion 14, the faller bar is removed from the mold. An end 18 can then be bent into the position shown in FIG. 2 to complete the faller bar to be ready for use for engagement with a driving mechanism. Alternatively, the end 18 can be bent prior to molding in which case the end can be held during molding to prevent rotation of the bar about its longitudinal axis.

It can be seen that no welds are necessary in order to allow the bar to take up the complete configuration both through the extent of the molded carbon fiber and at the driving end. Accordingly, the strength of the bar is increased considerably.

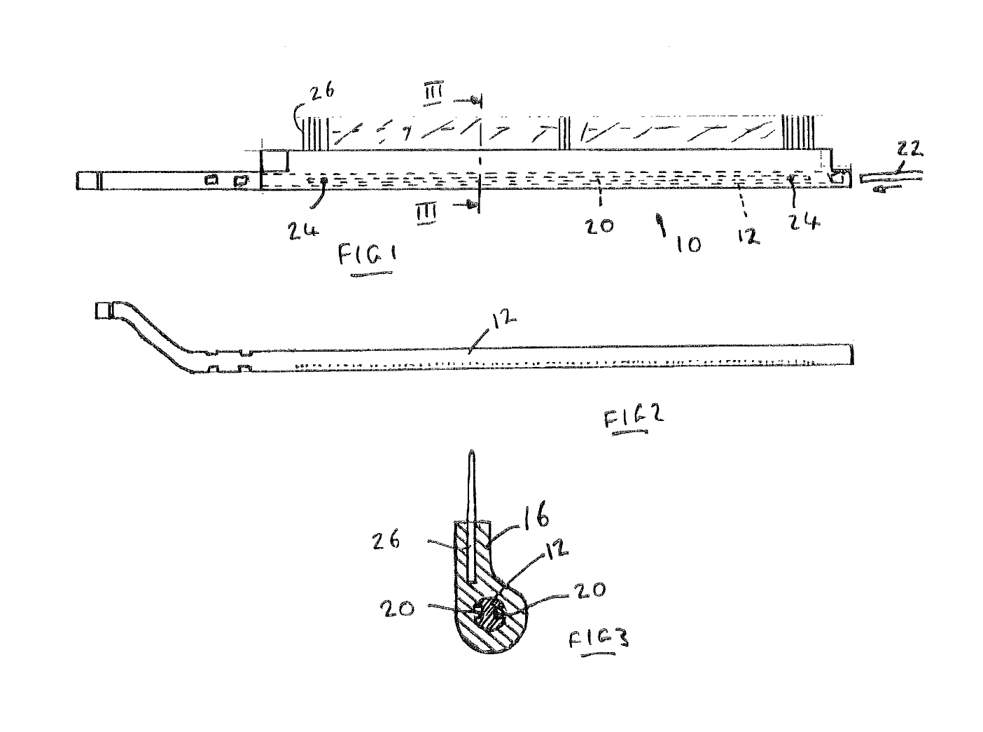

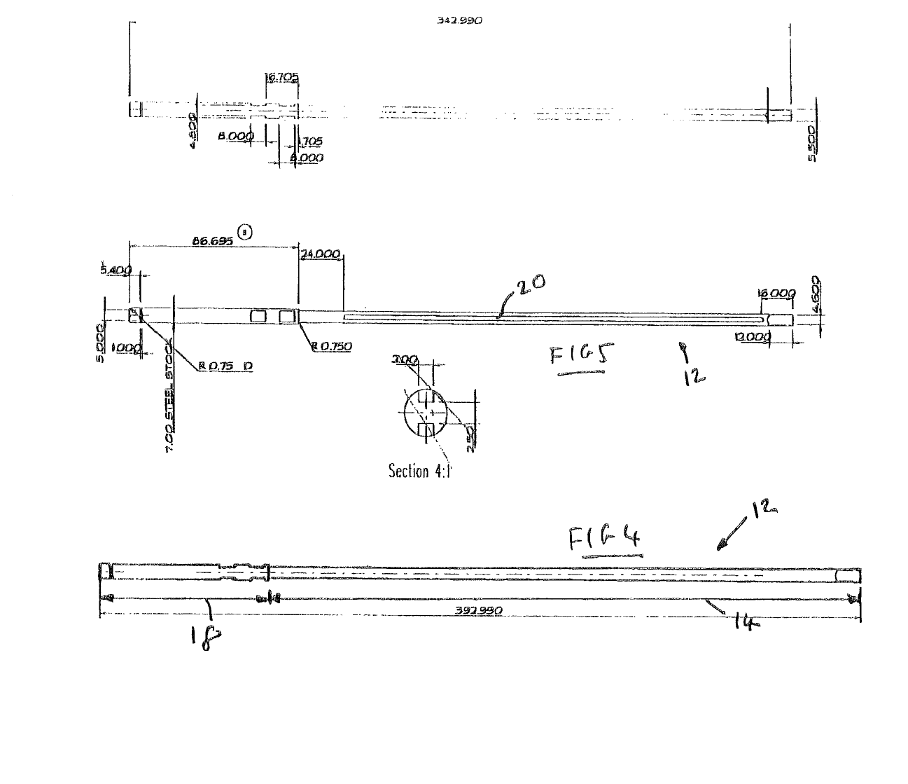

It could also be seen that the grooves 20 allow the major portion of the bar to comprise an I-beam. Accordingly, the bar is extremely strong and is able to resist any forces that may tend to cause the pins in the middle or at the end to move downwardly, when viewed in FIG. 1, with respect to other pins. In addition, the carbon fiber locks firmly around the bar as it fills the grooves 20.

The reader's attention is directed to all papers and documents which are filed concurrently with or previous to this specification in connection with this application and which are open to public inspection with this specification, and the contents of all such papers and documents are incorporated hereby by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of making a faller bar including a bar, a mold, holder and a series of pins comprising placing the bar in the mold and at least partially locating the bar in the mold by inserting the holders from opposite sides into recesses on opposite sides of the bar and subsequently molding pin support material at least partially around the bar and around part of the series of pins.

2. A method as claimed in claim 1 comprising inserting holders into least two spaced recessed parts of the bar from at least one side.

3. A method as claimed in claim 1 comprising inserting at least two spaced holders from one side of the bar and inserting at least two spaced holders from the other side of the bar with each of the holders from one side being aligned with a holder from the other side.

4. A method as claimed in claim 1 comprising inserting the holder into a recess such that the holding is able to engage with the bar to restrict relative longitudinal movement of the bar and holder.

5. A method as claimed in claim 1 comprising inserting a holder into a recess that extends along the bar.

6. A method as claimed in claim 5 comprising inserting a holder into a recess that extends along substantially the complete co-extent of the pin support material.

7. A method as claimed in claim 1 in which the holders are arranged to at least partially support the bar in the mold to restrict movement in an upwards direction.

8. A method as claimed in claim 1 in which the holders at least partially support the bar in the mold to resist movement in at least one direction extending in the direction of the elongate extent of the bar.

9. A method as claimed in claim 1 comprising inserting holders that do not contact the innermost part of the recesses.

10. A method as claimed in claim 9 comprising inserting holders from opposed sides that permit an extremely small amount of movement of the bar from side to side at the location of the holders.

11. A method as claimed in claim 1 comprising inserting a holder into an end portion of the bar to resist movement in at least one direction extending in the axial extent of the bar.

12. A method as claimed 1 comprising bending an end portion of the bar to form a driving portion.

13. A method as claimed in claim 12 comprising bending an end portion of the bar that is integral with the bar.

14. A method as claimed in claim 12 comprising restricting movement of the bent end portion about the elongate axis of the bar.

15. A faller bar including an elongate bar and a molded pin support, the bar including recesses on opposite sides said recesses arranged, in use, to have been engaged by holders having been inserted into those recesses when molding the pin support material at least partially around the bar and a series of pins to comprise the molded pin support.

16. A faller bar as claimed in claim 15 in which at least one of the recesses extends along substantially the complete co-extent of the bar with the molded pin support.

17. A faller bar as claimed in claim 15 in which at least one of the recesses comprises, in cross-section, a generally “U” shaped recess.

18. A faller bar as claimed in claim 15 in which the recesses form a bar, in cross-section of a generally I-shape.

19. A faller bar as claimed in claim 15 which is generally circular in cross-section prior to the recesses being formed.

20. A faller bar as claimed in claim 15 in which the bar includes a drive portion said drive portion being located at one end.

21. A faller bar as claimed in claim 10 in which said drive portion is integral with the bar.

22. A faller bar as claimed in claim 20 in which the general diameter of the elongate bar is less than the general diameter of the drive portion.
